(19) United States
(12) Patent Application Publication
(10) Pub. No.: US 2006/0253287 A1
(43) Pub. Date: Nov. 9, 2006

(54) Method and system for monitoring speech-controlled applications

(76) Inventors: Bernhard Kammerer, Taufkirchen (DE); Michael Reindl, Forchheim (DE)

Correspondence Address: SCHIFF HARDIN, LLP;PATENT DEPARTMENT, 6600 SEARS TOWER, CHICAGO, IL, 60606-6473, US

(21) Appl. No.: 11/402,346

(22) Filed: Apr. 12, 2006

(30) Foreign Application Priority Data
Apr. 12, 2005 (DE) 10 2005 016 853.1

(51) Int. Cl. G10L 21/00

(52) U.S. Cl. 704/275

(57) ABSTRACT

In a non-manual method and system for monitoring speech-controlled applications, a speech data stream of a user is acquired by a microphone and the speech data stream is analyzed by a speech recognition unit for the occurrence of stored key terms. An application associated with the key term is activated or deactivated upon detection of a key term within the speech data stream.

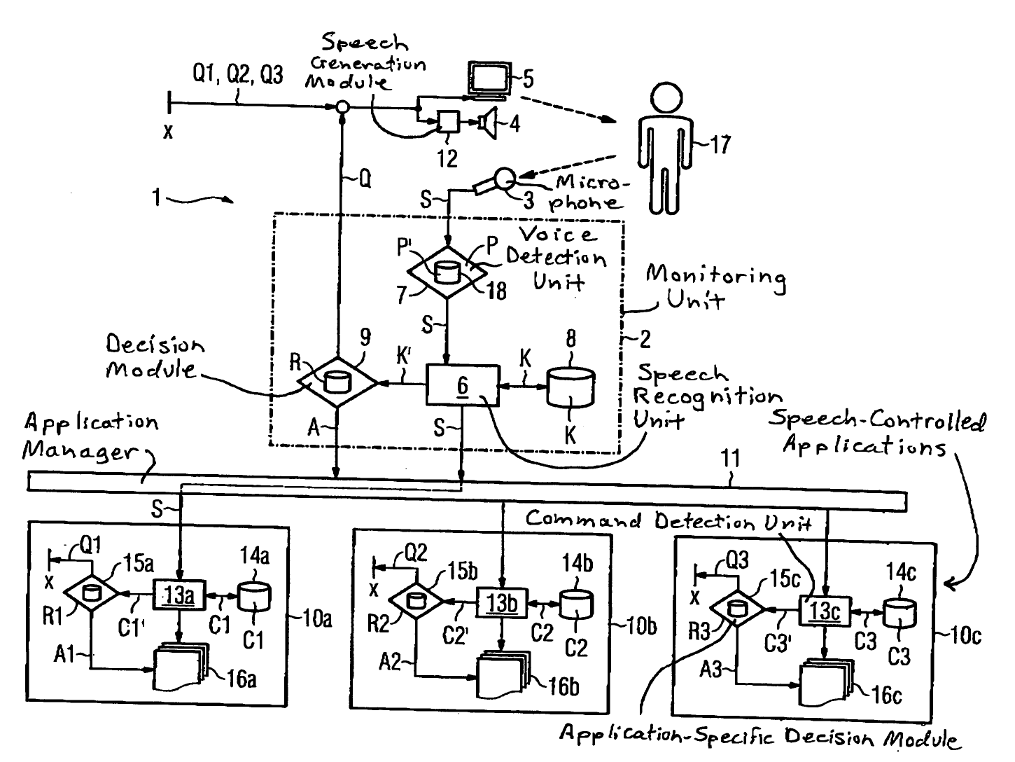

### BACKGROUND OF THE INVENTION

1. Field of the Invention

The present invention concerns a method for monitoring of speech-controlled applications. The invention furthermore concerns an associated monitoring system.

2. Description of the Prior Art

A software service program that can be operated by spoken language of a user is designated as a speech-controlled application. Such applications are known and are also increasingly used in medical technology. Examples are computer-integrated telephony systems (CTI), dictation programs, as well as speech-linked control functions for technical (in particular medical-technical) apparatuses or other service programs are counted among these.

Conventionally, such applications have been implemented independently of one another, thus requiring manually operable input means (such as a keyboard, mouse etc.) to be used in order to start applications, to end applications or to switch between various applications. Alternatively, various functions (for example telephone and apparatus control) are sometimes integrated into a common application. Such applications, however, are highly specialized and can only be used in a very narrow application field.

### SUMMARY OF THE INVENTION

An object of the present invention is to provide a method for monitoring speech-controlled applications that enables a particularly simple monitoring of speech-controlled applications that is not bound to manual inputs and that can be flexibly used. A further object to provide a suitable monitoring system for implementation of the method.

The above object is inventively achieved by a method and system wherein a speech data stream of a user is acquired by a microphone. A continuous sequence of phonetic data as they arise via the acquired and digitized speech of a user is understood as a speech data stream. The acquired speech data stream is examined (by means of an application-independent or application-spanning speech recognition unit) for the occurrence of stored key terms that are associated with an application monitored by the method or the monitoring system. Overall, one or more key terms are stored with regard to each application. If one of these key terms is identified within the acquired speech data stream, the associated application is thus activated or deactivated depending on the function of the key term. In the course of the activation, the application is started or, in the event that the appertaining application has already been started, raised into the foreground of (emphasized at) a user interface. In the course of the deactivation, the active application is ended or displaced into the background (deemphasized at) of the user interface.

For example, the key terms “dictation”, “dictation end” and “dictation pause” are stored for a dictation application. The application is activated, i.e. started or displaced into the foreground, via the key term “dictation”. The application is deactivated, i.e. ended or displaced into the background, via the key terms “dictation end” and “dictation pause”.

The monitoring of speech-controlled applications is significantly simplified by the method and the associated monitoring system. In particular the user can start, end the available applications by speaking the appropriate key terms and switch between various applications without having to use his or her hands, possibly also without having to make eye contact with a screen or the like. In particular an efficient, time-saving operating mode is enabled.

The monitoring system forms a level superordinate to the individual applications and independent from the latter, from which level the individual applications are activated as units that in turn see themselves as independent. The monitoring system thus can be flexibly used for controlling arbitrary speech-controlled applications and can be simply adapted to new applications.

A voice detection unit is preferably connected upstream from the speech recognition unit, via which voice detection unit it is initially checked whether the acquired speech data stream originates from an authorized user. This analysis can be achieved by the voice detection unit deriving speech characteristics of the speech data stream (such as, for example, frequency distribution, speech rate etc.) per sequence and comparing these speech characteristics with corresponding stored reference values of registered users. If a specific temporal sequence of the speech data stream can be associated with a registered user, and if this user can be verified as authorized (for example directly “logged in” or provided with administration rights (authorization)), the checked sequence of the speech data stream is forwarded to the speech recognition unit. Otherwise the sequence is discarded.

Improper access by a non-authorized user to the applications is prevented in this manner. The speech recognition thus supports security-related identification processes (such as, for example, password input) or can possibly replace such processes. Additionally, through the speech recognition the speech portion of an authorized user is automatically isolated from the original speech data stream. This is in particular advantageous when the speech data stream contains the voices of multiple speakers, which is virtually unavoidably the case given the presence of multiple people in a treatment room or open office. Other interference noises are also removed from the speech data stream by the speech filtering, and thus possible errors caused by interference noises are automatically eliminated.

In a simple embodiment of the invention, the associated application is immediately (directly) activated upon detection of a key term within the speech data stream. As an alternative, an interactive acknowledgement step can occur upstream from the activation of the application, in which acknowledgement step the speech recognition unit initially generates a query to the user. The application is activated only when the user positively acknowledges the query. The query can selectively be visually output via a screen and/or phonetically via speakers. The positive or negative acknowledgement preferably ensues by the user speaking a response (for example “yes” or “no”) into the microphone. Such a response is provided for the case that a key term was only identified with residual uncertainty in the speech data stream or multiple association possibilities exist. In the latter case, a list of possibly-relevant key terms is output in the framework of the query The positive acknowledgement of the user hereby ensues via selection of a key term from the list.

Two alternative method approaches are described as to how the detection of a key term and the activation of the associated application thereby triggered with a previously-active application should proceed. According to the first variant, given detection of the key term the previously-active application is automatically deactivated, such that the previously-active application is replaced by the new application. According to the second variant the previously-active application is left in an active state in addition to the new application, such that multiple active applications exist in parallel. The selection between these alternatives preferably ensues using stored decision rules that establish the method approach for each key term as well as, optionally, dependent on addition criteria (in particular dependent on the previously-active application).

If, for example, a dictation is interrupted by a telephone conversation, it is normally not intended for the dictation to simultaneously continue to run during the telephone conversation. In this case, the previous application (dictation function) would consequently be deactivated upon detection of the key term (for example “telephone call”) triggering the new application (telephone call). If a dictation is requested during a telephone call, the retention of the telephone connection during the dictation is normally intended, in particular in order to record the content of the telephone call in the dictation. For this situation the telephone application is left in an active state upon detection of the key term requesting the dictation.

The speech data stream can be forwarded from the speech recognition unit to each or the active application for further processing. Optionally, the speech recognition unit cuts detected key terms from the speech data stream to be forwarded in order to prevent misinterpretation of these key terms by the application-specific processing of the speech data stream. For example, in this manner writing of the keyword “dictation” is avoided by the dictation function activated thereby.

Speech recognition with regard to keywords stored specific to the application preferably occurs in turn at the application level. These application-specific keywords are subsequently designated as “commands” for differentiation from the application-spanning key terms introduced in the preceding. An application-specific action is associated with each command, which action is triggered when the associated command is detected within the speech data stream.

For example, in the framework of a dictation application such a command is the instruction to delete the last dictated word or to store the already-dictated text. For example, the instruction to select a specific number is stored as a command in the framework of a computer-integrated telephone application.

### DESCRIPTION OF THE DRAWINGS

The single figure shows a monitoring system for monitoring of three speech-controlled applications in accordance with the invention, in a schematic block diagram.

### DESCRIPTION OF THE PREFERRED EMBODIMENTS

The basic component of the monitoring system 1 is a monitoring unit 2 (realized as a software module) that is installed on a computer system (not shown in detail) and accesses input and output devices of the computer system, in particular a microphone 3, a speaker 4 as well as screen 5. The monitoring unit 2 is optionally implemented as a part of the operating system of the computer system.

The monitoring unit 2 includes a speech recognition unit 6 to which is supplied a digitized speech data stream S acquired via the microphone 3 is supplied. A voice detection unit 7 is connected between the speech recognition unit 6 and the microphone 3.

The speech recognition unit 6 examines (evaluates) the speech data stream S for the presence of key terms K, and for this references a collection of key terms K that are stored in a term storage 8. The monitoring unit 2 furthermore has a decision module 9 to which key terms K′ detected by the speech recognition unit 6 are forwarded and that is configured to derive an action (procedure) dependent on a known key term K′ according to the requirement of stored decision rules R.

The action can be the activation or deactivation of an application 10a-10c subordinate to the monitoring system 1. For this purpose, the decision module accesses an application manager 11 that is fashioned to activate or deactivate the applications 10a-10c. The action also can be a query Q that the decision module 9 outputs via the output means (i.e. the screen 5) and/or via the speaker 4. For this purpose, a speech generation module 12 that is configured for phonetic translation of text is connected upstream from the speaker 4.

The application 10a is, for example, a dictation application that is fashioned for conversion of the speech data stream S into written text. The application 10b is, for example, a computer-integrated telephone application. The application 10c is, for example, a speech-linked control application for administration and/or processing [handling] of patent data (RIS, PACS, . . . ).

If one of the applications 10a-10c is active, the speech data stream S is fed to it by the application manager 11 for further processing. In the figure, the dictation application 10 is shown as active as an example,

For further processing of the speech data stream S, each application 10a-10c has a separate command detection unit 13a-13c that is configured to identify a number of application-specific, stored commands C1-C3 within the speech data stream S. For this purpose, each command detection unit 13a-13c accesses a command storage 14a-14c in which are stored the commands C1-C3 to be detected in the framework of the respective application 10a-10c. Furthermore, an application-specific decision module 15a-15c is associated with each command detection unit 13a-13c, the decision modules 15a-15c are configured to trigger an action A1-A3 associated with the respective detected command C1′-C3′ using application-specific decision rules R1-R3, and for this purpose to execute a sub-routine or functional unit 16a-16c. As an alternative, the decision modules 15a-15c can be configured to formulate a query Q1-Q3 and (in the flow path linked in the figure via jump labels X) to output the query Q1-Q3 via the screen 5 or the speaker 4.

The operation of the monitoring system 1 ensues by a user 17 speaking into the microphone 3. The speech data stream S thereby generated is (after preliminary digitization) initially fed to the voice detection unit 7. In the voice detection unit 7 the speech data stream S is analyzed as to whether it is to be associated with a registered user. This analysis ensues in that the voice detection unit 7 derives one or more characteristic quantities P that are characteristic of human speech from the speech data stream S. Each determined characteristic quantity P of the speech data stream S is compared with a corresponding reference quantity P′ that is stored for each registered user in a user databank 18 of the voice detection unit 7. When the voice detection unit 7 can associate the system S with a registered user (and therewith identify the user 17 as being known) using the correlation of characteristic quantities P with reference quantities P′, the voice detection unit 7 checks in a second step whether the detected user 17 is authorized (i.e. possesses an access right). This is in particular the case when the user 17 is directly logged into the computer system or when the user 17 possesses administrator rights. If the user 17 is also detected as authorized, the speech data stream S is forwarded to the speech recognition unit 6. By contrast, if the speech data stream S cannot be associated with any registered user or the user 17 is recognized but identified as not authorized, the speech data stream S is discarded. The access is automatically refused to the user 17.

The voice detection unit 7 thus acts as a continuous access control and can hereby support or possibly even replace other control mechanisms (password input etc.).

The voice detection unit 7 checks the speech data stream S continuously and in segments. In other words, a temporally delimited segment of the speech data stream S is continuously checked. Only this segment is discarded when it is to be associated with no authorized user. The voice detection unit 7 thus also performs a filter function by virtue of components of the speech data stream S that are not associated with an authorized user (for example acquired speech portions of other people or other interference noises) being automatically removed from the speech data stream S that is forwarded to the speech recognition unit 6.

In the speech recognition unit 6, the speech data stream is examined for the presence of the key terms K stored in the term storage 8. For example, the key terms K “dictation”, “dictation pause” and “dictation end” are stored in the term storage 8 as associated with the application 10a, the key term K “telephone call” is stored in the term storage 8 as associated with the application 10b and the key terms K “next patient” and “Patient <Name>” are stored in the term storage 8 as associated with the application 10c. <Name> stands for a variable that is occupied with the name of an actual patient (for example “Patient X”) as an argument of the key term “Patient <. . . >”. Furthermore, the key terms K “yes” and “no” are stored in the term storage 8.

If the speech recognition unit 6 detects one of the stored key terms K within the speech data stream S, it forwards this detected key term K′ (or an identifier corresponding to this) to the decision module 9. Using the stored decision rules R, this decision module 9 determines an action to be taken. Dependent on the detected key term K′, this can comprise the formulation of the corresponding query Q or an instruction A to the application manager 11. In the decision rules R, queries Q and instructions A are stored differentiated according to the preceding key term K′ and/or a previously-active application 10a-10c.

If, for example, the word “dictation” is detected as a key term K′ while the dictation application 10a is already active, the decision module 9 formulates the query Q ♭Begin new dictation?”, outputs this via the speaker 4 and/or via the screen and waits for an acknowledgement by the user 17. If the user 17 positively acknowledges this query Q with a “yes” spoken into the microphone 3 or via keyboard input, the decision module 9 outputs to the application manager 11 the instruction A to deactivate (to displace into the background) the previous dictation application 10a and to open a new dictation application 10a. The detected key term K′ “dictation” is hereby appropriately erased from the speech data stream S and is thus written neither by the previous dictation application 10a nor by the new dictation application 10a. If the user acknowledges the query 0 negatively (by speaking the word “no” into the microphone 3 or by keyboard input) or if no acknowledgement by the user 17 occurs at all within a predetermined time span, the decision module 9 aborts the running decision process: the last detected key term K′ “dictation” is erased. The previous dictation is continued, i.e. the previously-active dictation application 10a remains active.

By contrast, if the key term K′ “dictation” is detected during a telephone call (previously active: telephony application 10b), the output of the instruction to activate the dictation application 10a is provided by the decision rules R without deactivating the previously-active telephony application 10b. The applications 10a and 10b are active in parallel, such that the text spoken by the user 17 during the telephone call is simultaneously transcribed by the dictation application 10a. Optionally, the text spoken by the telephonic discussion partner of the user 17 is also derived and transcribed as a speech data stream S at the dictation application.

In a corresponding manner, the decision rules R allow a number of telephone connections (telephone applications 10b) to be established in parallel and activated simultaneously or in alternating fashion. Likewise, dictations (dictation application 10a) and telephone calls (telephone application 10b) can be implemented in the framework of an electronic patient file (control application 10c, and an electronic patient file can be opened during a telephone call or a dictation by mentioning the key term K “Patient <Name>”.

Within each application 10a-10c, a speech recognition occurs in turn with regard to the respective stored commands C1-C3. For example, as commands C1-C3 the commands C1 “delete character”, “delete word” etc. are stored in the case of the dictation application 10a, the commands C2 “select <number>”, select <name>, “apply” etc. are stored in the case of the telephony application 10b. Via the decision module 15a-16c associated with the respective application 10a-10c, corresponding instructions A1-A3 or queries Q1-Q3 are generated with regard to detected commands C1-C3. Each instruction A1-A3 is executed by the respective associated function unit 16a-18c of the application 10a-10c; queries Q1-Q3 are output via the speaker 4 and/or the screen 5.

The command detection and execution ensues in each application 10a-10c independent of the other applications 10a-10c and independent of the monitoring unit 2. The command detection and execution can therefore be implemented in a different manner for each application 10a-10c without affecting [impairing] the function of the individual applications 10a-10c and their interaction. Due to the independence of the monitoring system 1 and of the individual applications 10a-10c, the monitoring system 1 is suitable to monitor any speech-controlled applications (in particular such speech-controlled applications of various vendors) and can be easily converted (retrofitted) upon reinstallation, deinstallation, or an exchange of applications.

Although modifications and changes may be suggested by those skilled in the art, it is the intention of the inventors to embody within the patent warranted hereon all changes and modifications as reasonably and properly come within the scope of their contribution to the art.

We claim as our invention:

1. A method for monitoring speech-controlled applications comprising the steps of:
acquiring a speech data stream with a microphone;
electronically examining said speech data stream to identify an occurrence of a term therein corresponding to a stored key term;
upon detection of a term in said speech data stream corresponding to a stored key term, implementing an action, selected from activation and deactivation, of a speech-controlled application associated with the stored key term; and
electronically forwarding said speech data stream to a unit for implementing the speech-controlled application for processing in said unit according to said action

2. A method as claimed in claim 1 comprising, before electronically analyzing said speech data stream, subjecting said speech data stream to at least one electronic voice detection check to determine whether said speech data stream originated from an authorized person, and electronically analyzing said speech data stream only if said speech data stream is determined to originate from an authorized person.

3. A method as claimed in claim 1 comprising, before implementing said action, electronically generating a humanly-perceptible query, and implementing said action only after electronically detecting a manual response to said query.

4. A method as claimed in claim 1 wherein the step of implementing said action comprises electronically consulting a set of stored decision rules to determine whether a previously-active one of said speech-controlled applications should be deactivated or left in an active state.

5. A method as claimed in claim 1 comprising, in said unit for implementing said speech-controlled application, electronically examining said speech data stream to identify a presence of a command therein corresponding to an application-specific stored command, and if a command corresponding to a stored command is present in said speech data stream, triggering a command action associated with said stored command.

6. A system for monitoring speech-controlled applications comprising:
a microphone that acquires a speech data stream;
a speech recognition unit that electronically examines said speech data stream to identify an occurrence of a term therein corresponding to a stored key term;
a decision module that, upon detection of a term by said speech recognition unit in said speech data stream corresponding to a stored key term, generates an output to implement an action, selected from activation and deactivation, of a speech-controlled application associated with the stored key term; and
an application manager that electronically forwards said speech data stream and said decision module output to an application unit for implementing the speech-controlled application for processing in said application unit according to said action.

7. A system as claimed in claim 6 comprising a voice recognition unit connected between said microphone and said speech recognition unit, that subjects said speech data stream to at least one electronic voice detection check to determine whether said speech data stream originated from an authorized person, and passes said speech data stream to said speech recognition unit only if said speech data stream is determined to originate from an authorized person.

8. A system as claimed in claim 6 wherein said application unit, before implementing said action, electronically generates a humanly-perceptible query, and implementing said action only after electronically detecting a manual response to said query.

9. A system as claimed in claim 6 wherein the decision module electronically consults a set of stored decision rules to determine whether a previously-active one of said speech-controlled applications should be deactivated or left in an active state.

10. A system as claimed in claim 6 comprising, in said application unit for implementing said speech-controlled application, electronically examining said speech data stream to identify a presence of a command therein corresponding to an application-specific stored command, and if a command corresponding to a stored command is present in said speech data stream, triggering a command action associated with said stored command.
